(19) United States
(12) Patent Application Publication
(10) Pub. No.: US 2006/0119561 A1
(43) Pub. Date: Jun. 8, 2006

(54) Image display apparatus, image signal converting device, image signal converting method, image signal converting program

(75) Inventor: Hiroshi Hasegawa, Chino-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/272,695

(22) Filed: Nov. 15, 2005

(30) Foreign Application Priority Data
Dec. 3, 2004 (JP) 2004-350812

(51) Int. Cl. G09G 3/36

(52) U.S. Cl. 345/98

(57) ABSTRACT

An image display apparatus for displaying images using a liquid crystal panel according to the invention includes: a parameter storing section for storing correction parameters associated with response characteristics for voltage applied to each pixel of the liquid crystal panel; and a parameter reading section for reading the correction parameters stored in the parameter storing section. The liquid crystal panel of the image display apparatus is operated in accordance with an image signal corrected based on the correction parameters read by the parameter reading section.

### BACKGROUND

1. Technical Field

The present invention relates to an image display apparatus which displays still images and dynamic images using a liquid crystal panel, an image signal converting device, an image signal converting method, an image signal converting program, and a storage medium in which the program is stored.

2. Related Art

Recently, an image display apparatus using a liquid crystal panel has taken the place of a CRT (cathode-ray tube) as the mainstream of a personal computer display, and also has been used as a television display system and a projection-type display system (liquid crystal projector).

The image display apparatus displays gradations by utilizing light transmissivity which varies in accordance with voltage applied to each pixel. However, since the light transmissivity, in fact, responds to applied voltage at a low speed, deterioration of image quality such as tailing and blurring occurs especially when dynamic images are displayed.

For example, according to the color standards for the analog television established by NTSC (National Television Standards Committee) which are commonly used in the United States, Japan and other countries, 29.97 frames per second are required to be displayed. That is, a period of approximately 33 microseconds is allowed as the display time of one frame. However, it is known that the normal response time of a typical active-matrix-type liquid crystal panel is as long as 20 to 30 microseconds, and it is therefore impossible to obtain appropriate transmissivity only by applying driving signals (voltage) to each pixel of the liquid crystal panel according to the timing at which timing is desired.

In order to prevent such deterioration of displaying quality of dynamic images due to the response characteristics, a method which utilizes the inherent characteristic of typical liquid crystal materials that the response speed increases as the variation range of applied voltage widens has been proposed (see JP-A-3-174186, JP-A-2001-331154 and JP-A-2004-246118).

According to the method disclosed in JP-A-3-174186, a fluctuation curve of transmissivity is calculated in advance based on a formula which determines the relationship between the applied voltage and the response time, and the calculated fluctuation curve is stored in a data table. Then, voltage is corrected so as to produce required transmissivity by referring to correction values obtained from the fluctuation curve using a corrector.

According to this method, however, since the fluctuation curve of transmissivity for a plurality of fields (three or more fields in succession) is estimated and correction is made based on the estimation, it is necessary to obtain for every pixel the fluctuation curves for the plurality of fields which need to be estimated and store the curves in the table. Thus, a number of storing means such as ROMs (Read Only Memory) are required for precise control, and sufficient tables need to be prepared so that various patterns of correction can be made.

According to the method disclosed in JP-A-2001-331154 as an improvement of the above method, a correction amount is determined from the difference between picture signals in a certain field and those in the previous field, and is added or multiplied.

According to this method, however, since information obtained is limited to only one field, adverse effects such as noise are produced, or insufficient correction is made in some cases. Thus, deterioration of images cannot be securely prevented.

The method disclosed in JP-A-2004-246118 has been proposed for overcoming the drawbacks arising from the method of JP-2001-331154. In this method also, however, a correction is made using only picture signals in the current field and the previous field ahead. Thus, insufficient correction may be made for fundamental reasons.

Furthermore, since static response characteristics and time response characteristics (rise characteristics, falling characteristics, and leak characteristics) differ for each pixel in the actual liquid crystal panel, even if the same picture signal is given, the resulting output is different so that the image of each LCD panel has distinctive disuniformities which deteriorate picture quality.

### SUMMARY

An advantage of some aspects of the invention is to provide an image display apparatus, an image signal converting device, an image signal converting method, an image signal converting program, and a storage medium in which the program is stored, which are capable of displaying images having excellent quality regardless of response characteristics inherent in each pixel of a liquid crystal panel.

An image display apparatus for displaying images (including still images and dynamic images) using a liquid crystal panel according to a first aspect of the invention includes: a parameter storing section for storing correction parameters associated with response characteristics to voltage applied to each pixel of the liquid crystal panel; and a parameter reading section for reading the correction parameters stored in the parameter storing section. The liquid crystal panel of the image display apparatus is operated in accordance with an image signal corrected based on the correction parameters read by the parameter reading section.

The above response characteristics include static response characteristics showing the level of transmissivity for the applied voltage, rise characteristics and falling characteristics of transmissivity relative to the applied voltage, light leak characteristics in the case where a set voltage is continuously applied, and other characteristics. The rise characteristics, the falling characteristics and the leak characteristics are referred to as time response characteristics.

According to the first aspect of the invention, since the image signal is precisely corrected such that it is optimized for each pixel of the liquid crystal panel, more excellent image quality than in the related art can be achieved.

It is preferable that the image display apparatus according to the first aspect of the invention further includes a device that passes light which allows light emitted from a light source to pass through pixels only for a predetermined period within a frame cycle of an image.

In this case, since the light does not always pass through the pixels during the frame cycle, it is difficult for the light to leak from the respective pixels. Since as a result, correction parameters for the leak characteristics are not required, correction of the image signal can be facilitated and the memory capacity for storing the correction parameters can be decreased.

In the image display apparatus according to the first aspect of the invention, it is preferable that the light source is a solid light source and that the device that passes light is a driving circuit for allowing the solid light source to be periodically turned on and off, or else the light source is a gaseous light emitting source and that the device that passes light is a blocking member for periodically blocking light emitted from the gaseous light emitting source. In this structure, light can reliably be made to pass through the liquid crystal panel only for a predetermined period within the frame cycle.

In the first aspect of the invention, an LED (light emitting diode) is preferably used as the solid light source, and a metal halide lamp, a halogen lamp, high-pressure mercury lamp or the like is preferably used as the gaseous light emitting source.

On the other hand, a rotational light blocking plate having a plurality of transparent slits at equal circumferential intervals on the circumference of a disk-shaped rotor, or a plurality of polarization plates overlapping with their lattice axes either aligned with one another or intersecting one another at predetermined angles are preferably used as the light blocking member.

An image signal converting device according to a second aspect of the invention includes a data converting section for correcting an image signal based on the correction parameters for each pixel obtained from the image display apparatus according to the first aspect of the invention; and a data output section for outputting the corrected image signal to the image display apparatus.

In this case, the image signal converting device corrects an image signal, and the image display apparatus displays an image based on the corrected image signals. As a result, a high-quality image can be displayed.

It is preferable that the image signal converting device according to the second aspect of the invention further includes a control signal producing section which produces a control signal for controlling the device that passes light.

In this case, since the control signal producing section is provided not on the image display apparatus but on the image signal converting device as is the data converting section, signal producing functions for creating high-quality images are collected on the image signal converting device. As a result, circuit design and the like can be facilitated.

In an image signal converting method according to a third aspect of the invention, the image signal converting device according to the second aspect of the invention executes: correction of an image signal based on correction parameters for each pixel obtained from the image display apparatus according to the first aspect of the invention; and output of the corrected image signal to the image display apparatus.

In this case, a high quality image can be displayed as in the case of the image signal converting device according to the second aspect of the invention.

In the image signal converting method according to the third aspect of the invention, it is preferable that the correction parameters are divided into a plurality of groups, and that a coefficient table in which the groups and the correction parameters are associated and a pixel table in which pixels and are associated with their respective groups are prepared. It is also preferable that the image signal converting device determines the group corresponding to each pixel from the pixel table, selects the correction parameters corresponding to the determined group from the coefficient table, and corrects the image signal based on the selected correction parameters.

In this case, since the correction parameters are divided into a plurality of groups, it is unnecessary to individually establish correction parameters for each pixel. As a result, the memory capacity for storing the correction parameters can be securely decreased.

Classification of the correction parameters may be made through cluster analysis, main component analysis or by other methods.

Under an image signal converting program according to a fourth aspect of the invention, the image signal converting device according to the second aspect of the invention using a computer executes: correcting an image signal based on correction parameters for each pixel obtained from the image display apparatus according to the first aspect of the invention; and outputting the corrected image signal to the image display apparatus.

A storage medium in which a program for correcting an image signal according to a fifth aspect of the invention is a storage medium in which the image signal converting program according to the fourth aspect of the invention is stored. In this case, a ROM, a hard disk or any other medium can be used as the storage medium.

### BRIEF DESCRIPTION OF THE DRAWINGS

The invention will be described with reference to the accompanying drawings, wherein the same numbers refer to the same elements.

FIG. 1 is a block diagram schematically illustrating a structure of an image display apparatus in a first embodiment according to the invention.

FIG. 2 is a plan view schematically illustrating a main part of the image display apparatus in the first embodiment.

FIG. 3 shows a coefficient table and a pixel table.

FIG. 4 is a block diagram schematically illustrating a structure of an image signal converting device in the first embodiment.

FIG. 5 is a flowchart showing steps for correcting an image signal.

FIG. 6 is a block diagram schematically illustrating a structure of an image display apparatus in a second embodiment according to the invention.

FIG. 7 is a plan view schematically illustrating a main part of the image display apparatus in the second embodiment.

### DESCRIPTION OF EXEMPLARY EMBODIMENTS

Several embodiments according to the invention are hereinafter described with reference to the drawings. In a second embodiment which will be described later, similar reference numerals are given to structures and their functions similar to those in the first embodiment described below, and the explanation of those is omitted or simplified in the second embodiment.

### First Embodiment

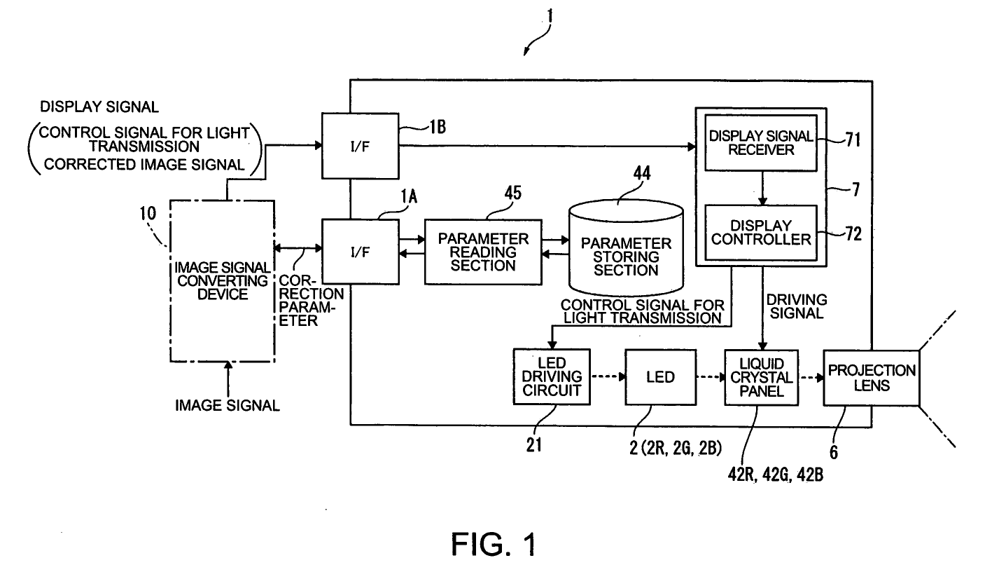

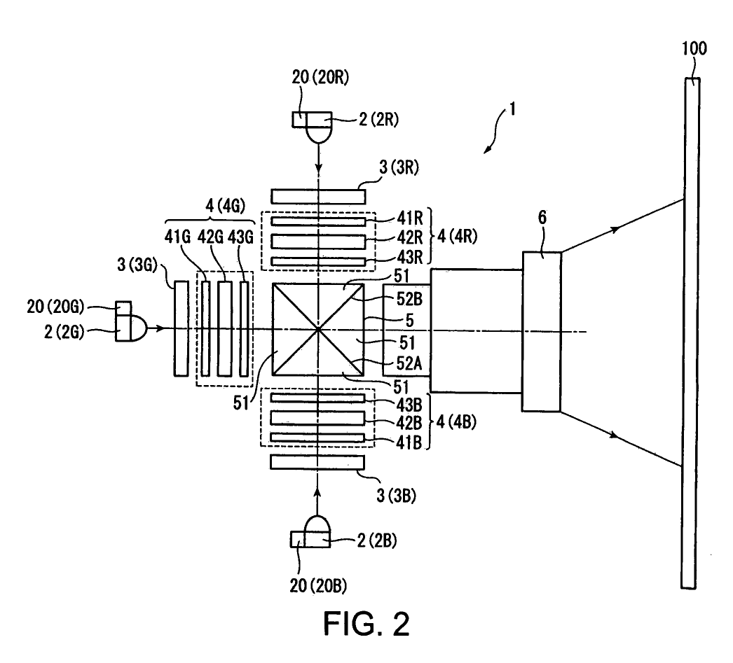

FIG. 1 is a block diagram schematically illustrating a structure of a liquid crystal projector 1 as an image display apparatus in a first embodiment according to the invention. FIG. 2 is a plan view schematically illustrating the main part of the liquid crystal projector 1.

As illustrated in FIGS. 1 and 2, the liquid crystal projector 1 modulates light emitted from LEDs 2 (2R, 2G and 2B) which here are the solid light sources, in accordance with an image signal for a still image or a dynamic image to produce an optical image, and then enlarges and projects the produced optical image on a screen 100. The liquid crystal projector 1 is a three-plate-type projector which includes three polarization conversion devices 3 (3R, 3G and 3B), three electro-optical devices 4 (4R, 4G and 4B), a cross dichroic prism 5, a projection lens 6, and a driving device 7.

The LEDs 2, operated by an LED driving circuit 21 which here is the device that passes light, are repeatedly turned on and off to intermittently emit light to the polarization conversion devices 3. The LED 2R, the LED 2G and the LED 2B emit red light, green light and blue light, respectively. The LEDS 2 are constituted by LED elements as a plurality of solid light emission elements arranged on an Si substrate. The LED driving circuit 21 applies driving voltage to the LED elements in accordance with a control signal for light transmission sent from an image signal converting device 10 which will be described later.

The polarization conversion devices 3 are constituted by the three polarization conversion devices 3R, 3G and 3B corresponding to lights of respective colors emitted from the LEDs 2, and convert the polarization directions of the lights in the respective colors into linear polarized lights that are substantially unidirectional. In this embodiment, the polarization conversion devices 3R and 3B convert red and blue lights emitted from the LED 2R and LED 2B, respectively, into P-polarized lights and emit the converted lights, while the polarization conversion device 3G converts green light emitted from the LED 2G into S-polarized lights and emits the converted lights.

The electro-optical devices 4 are constituted by the electro-optical devices 4R, 4G and 4B corresponding to lights in respective colors emitted from the polarization conversion devices 3R, 3G and 3B, respectively. The electro-optical devices 4 vary the transmission rate of lights emitted from the polarization conversion devices 3R, 3G and 3B in accordance with gradation data carried on an inputted image signal under the control of the driving device 7 which will be described later, so as to modulate the entering color lights and produce an optical image. The electro-optical devices 4 have three entrance-side polarization plates 41R, 41G and 41B, three liquid crystal panels 42R, 42G and 42B, and three exit-side polarization plates 43R, 43G and 43B.

The liquid crystal panels 42R, 42G and 42B of the electro-optical devices 4, which are omitted in the diagrams, have liquid crystals as electro-optical substances sealed between a pair of transparent glass substrates. The orientations of the liquid crystals included in the liquid crystal panels 42R, 42G and 42B, i.e., their transmissivity is controlled for each pixel in accordance with the driving signal sent from the driving device 7, whereby the polarization directions of the polarized lights emitted from the entrance-side polarization plates 41R, 41G and 41B are modulated.

The cross dichroic prism 5 is an optical element which synthesizes optical images formed by the color lights each of which is modulated by the corresponding electro-optical device 4R, 4G or 4B and emitted therefrom, and produces a color image from the synthesized optical images. The cross dichroic prism 5 is a substantially square-shaped component in the plan view formed by combining four rectangular prisms 51, and dielectric multilayer films 52A and 52B are provided on the boundaries between the adjoining rectangular prisms 51.

The projection lens 6 enlarges the color image produced by the cross dichroic prism 5 and projects the enlarged color image on the screen 100. The projection lens 6 is a composite lens formed by combining a plurality of lenses, and is accommodated within a mirror cylinder.

The driving device 7 for applying driving voltage to the liquid crystal panels 42R, 42G and 42B includes a display signal receiver 71 for receiving a display signal constituted by an image signal and a control signal for light transmission through a predetermined interface (IF) lA, and a display controller 72 for outputting a driving signal produced in accordance with the image signal included in the display signal to the liquid crystal panels 42R, 42G and 42B and for outputting the control signal for light transmission included in the display signal to the LED driving circuit 21.

In this embodiment, the image signal to be inputted to the liquid crystal projector 1 is corrected by the image signal converting device 10. This correction is made based on correction parameters determined considering the response characteristics of the liquid crystal panels 42R, 42G and 42B for each pixel. Since the driving signal for actuating each pixel of liquid crystal panels 42R, 42G and 42B is produced based on the corrected image signal, each pixel operates in accordance with optimal driving signals. As a result, a high-quality display image having reduced picture non-uniformity can be produced.

The response characteristics of each pixel herein include static response characteristics such as the level of transmissivity for the applied voltage of the driving signal, and the time response characteristics (rise characteristics and falling characteristics) to the applied voltage. In this embodiment, since light is intermittently emitted from the LEDs 2 and passes through each pixel only for a predetermined time period within a frame cycle, the transmission period is short. Accordingly, there is no possibility of light leaks within a frame cycle, and thus consideration of the leak characteristics is not needed.

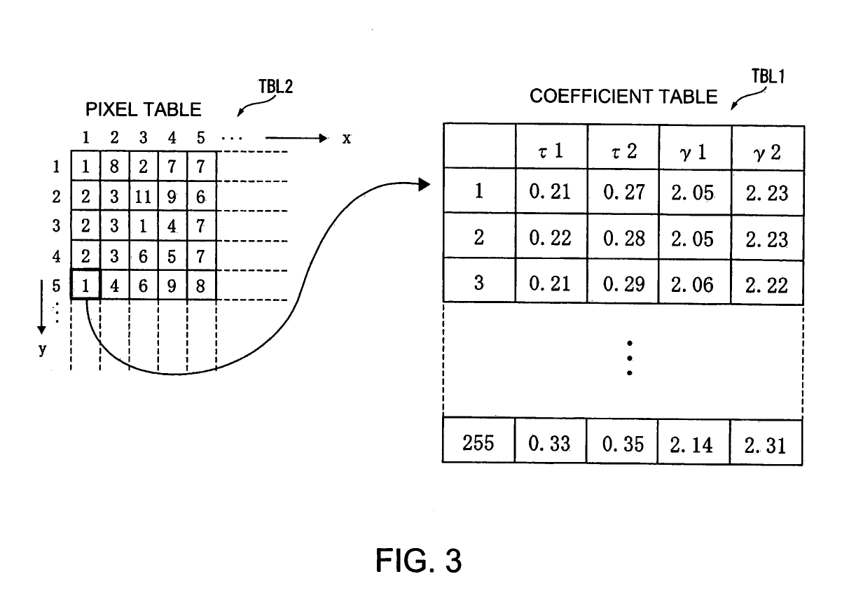

As illustrated in FIG. 3, two gamma coefficients γ1 and γ2 are correction parameters determined based on the static response characteristics, and two time constants τ1 and τ2 are correction parameters determined based on the time response characteristics. Two correction parameters are used for the respective characteristics because the driving signal of each pixel is constituted by two types of pulse signals one of which is in the low-voltage region and the other in the high-voltage region. Since there are close correlations among the gamma coefficients γ1 and γ2 and the time constants τ1 and τ2, cluster analysis or main component analysis is carried out. After the analysis, these are grouped into 255 types of typical parameter sets, for example. Group numbers from 1 to 255 are given to the correction parameter groups containing the time constants τ1 and τ2 and the gamma coefficients γ1 and γ2, and the correction parameter groups to which parameters are associated are written in a coefficient table TBL1.

The time response characteristics and the static response characteristics of each pixel are obtained by a predetermined method during the manufacturing process of the liquid crystal panels 42R, 42G and 42B, and appropriate correction parameters based on these response characteristics are determined for each pixel. Then, as illustrated in FIG. 3, a pixel table TBL2 which associates each pixel with the number of one group of correction parameters is prepared. As can be seen from the pixel table TBL2 shown in FIG. 3, a group number “1” is given to a pixel (x, y)=(1, 5) based on the response characteristics of the pixel. Thus, the correction parameters of τ1=0.21, τ2=0.27, γ1=2.05, and γ2=2.23 can be obtained by referring to the coefficient table TBL1, and the image signal for the pixel (1, 5) is corrected using these parameters.

For example, when the liquid crystal panels 42R, 42G and 42B are of XGA (extended graphics array) types, approximately 8 hundred thousand pixels are contained. It is therefore not practical to prepare individual correction parameters corresponding to the respective response characteristics for each pixel, since an enormous volume of memory would be needed. In this embodiment, the correction parameters are classified into groups 1 to 225 and each pixel is associated with a group number so that the correction parameters can be stored in a memory of small volume. For enhancing memory utilization efficiency, the table TBL2 may be compressed by a reversible compressing method which uses run length encoding, Huffman encoding or the like. Generally, pixels constituting the liquid crystal panel tend to have similar characteristics when they are positioned close to each other. Thus, the characteristics can be efficiently compressed in many cases.

The pixel table TBL2 is specifically prepared for use in the type of liquid crystal projector 1 in this embodiment, and is stored in a parameter storing section 44 with the coefficient table TBL1 which can be universally used in many liquid crystal projectors. The liquid crystal projector 1 is shipped from the factory with these tables TBL1 and TBL2. The group numbers of the respective pixels and the correction parameters written in the tables TBL1 and TBL2 are read out by a parameter reading section 45 in accordance with commands from the image signal converting device 10, and outputted through an interface 1B to the image signal converting device 10.

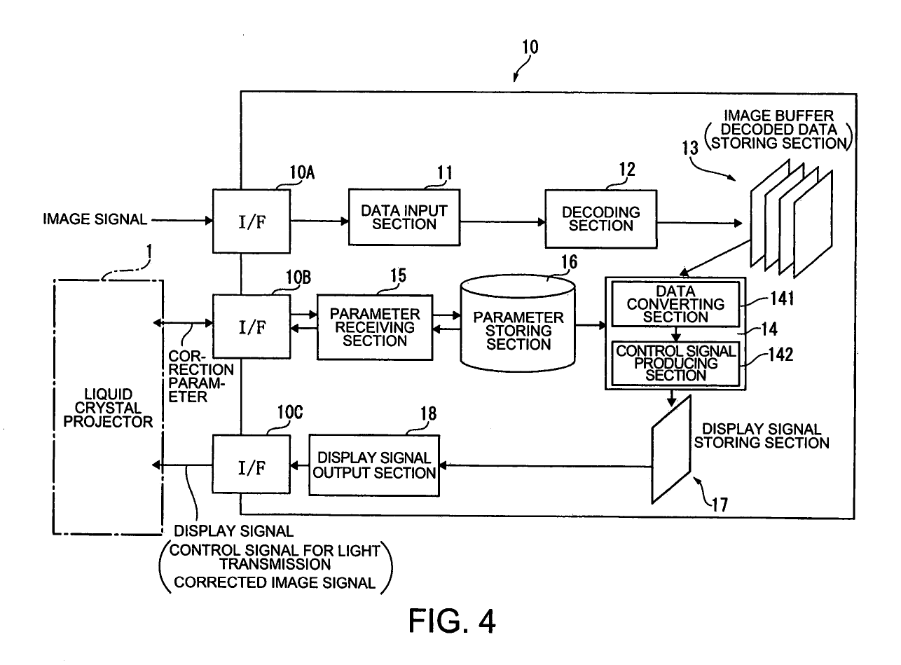

The image signal converting device 10 is now described in detail with reference to the block diagram shown in FIG. 4.

The image signal converting device 10 corrects an image signal inputted from an external device such as a personal computer and an AV (audio visual) device to make the image signal appropriate for the liquid crystal projector 1 using the correction parameters acquired therefrom, and outputs the corrected image signal to the liquid crystal projector 1.

More specifically, the image signal converting device 10 includes a data input section 11 for inputting an image signal from an external device through an interface 10A. The inputted image signal is divided into parts corresponding to each frame cycle by a decoding section 12, and stored in a decoded data storing section 13 as image buffers. The image signal converting device 10 further includes a processor 14 formed by a micro-computer or the like, a parameter receiver 15 for receiving the group numbers of the respective pixels and correction parameters from the liquid crystal projector 1 through an interface 10B, and a parameter storing section 16 which stores the received group numbers and correction parameters in the coefficient table TBL1 and the pixel table TBL2. The processor 14 of the image signal converting device 10 has a data converting section 141 and a control signal producing section 142.

The data converting section 141 corrects the data included in the image signal read from the decoded data storing section 13 based on the correction parameters stored in the parameter storing section 16 to produce the corrected image signal.

The control signal producing section 142 produces a control signal for light transmission, which intermittently turns on the LEDs 2 of the liquid crystal projector 1, in synchronization with the corrected image signal.

The corrected image signal and the control signal for light transmission are temporarily stored in the display signal storing section 17 as a display signal, and outputted from a display signal output section 18 as a section for data output through an interface 1C to the liquid crystal projector 1.

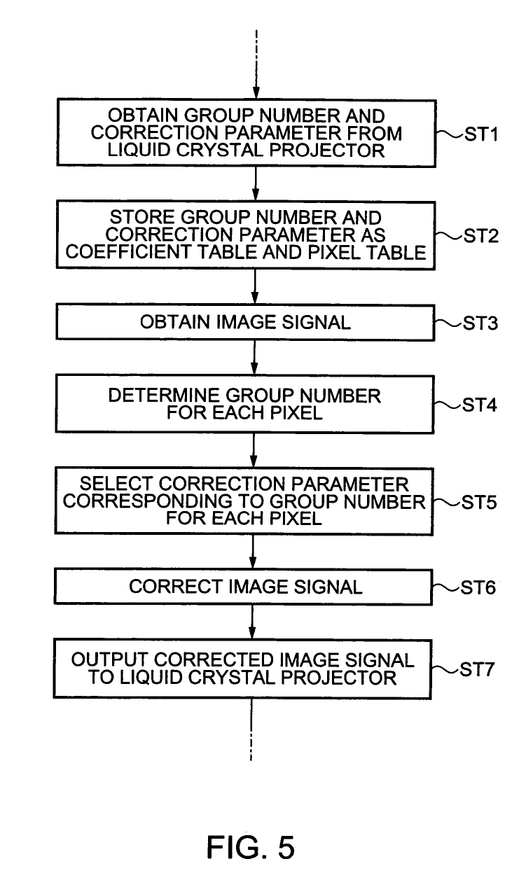

FIG. 5 is a flowchart showing simplified steps for correcting an image signal. These correction steps proceed according to an image signal converting program executed by the data converting section 141 of the processor 14. The image signal converting program is stored in a storage medium such as a ROM.

In FIG. 5, the data converting section 141 receives and acquires group numbers for the respective pixels and correction parameters from the liquid crystal projector 1 according to the image signal converting program prior to input of an image signal (ST1). Then, the data converting section 141 stores the group numbers and correction parameters in the parameter storing section 16 in the form of the coefficient table TBL1 and the pixel table TBL2 (ST2). When the table TBL2 is reversibly compressed as described above, the table TBL2 is expanded at the time of acquisition of the TBL2 and the result of expansion is stored.

Thereafter, the data converting section 141 obtains the inputted image signals for one frame (ST3), and determines the group numbers for the respective pixels from the pixel table TBL2 (ST4). Subsequently, the correction parameters corresponding to the respective pixels are selected from the coefficient table TBL1 according to the group numbers (ST5), and the image signal is corrected based on the correction parameters for the respective pixels (ST6). Then, the corrected image signal is outputted to the liquid crystal projector 1 together with the control signal for light transmission as the display signal (ST7). These steps are performed for each frame.

In the liquid crystal projector 1, the driving device 7 produces a driving signal in accordance with the corrected image signal and actuates each pixel. In producing the driving signal, the response characteristics of each pixel are taken into account so that the driving signal having an optimal waveform can be supplied to each pixel. For example, a driving signal having large voltage is applied to a pixel which has poor response characteristics. As a result, within one frame cycle desirable luminance average values are obtained for all the pixels, and thus even when a driving signal for displaying the same gradation is given to all the pixels, a high-quality uniform image without a part which is too dark or a part which is too bright can be displayed.

The liquid crystal projector 1 can receive an image signal directly from an outside device when the image signal converting device 10 is not connected to the liquid crystal projector 1. In this case, the picture non-uniformity cannot be sufficiently eliminated, but the liquid crystal projector 1 can provide image quality substantially equal to that of the related-art liquid crystal projector.

### Second Embodiment

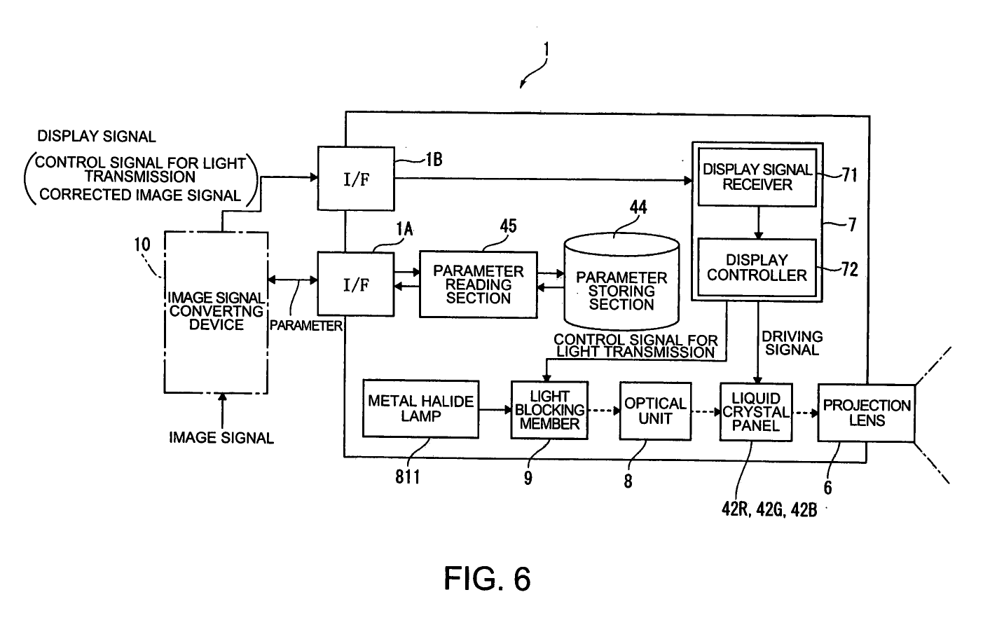

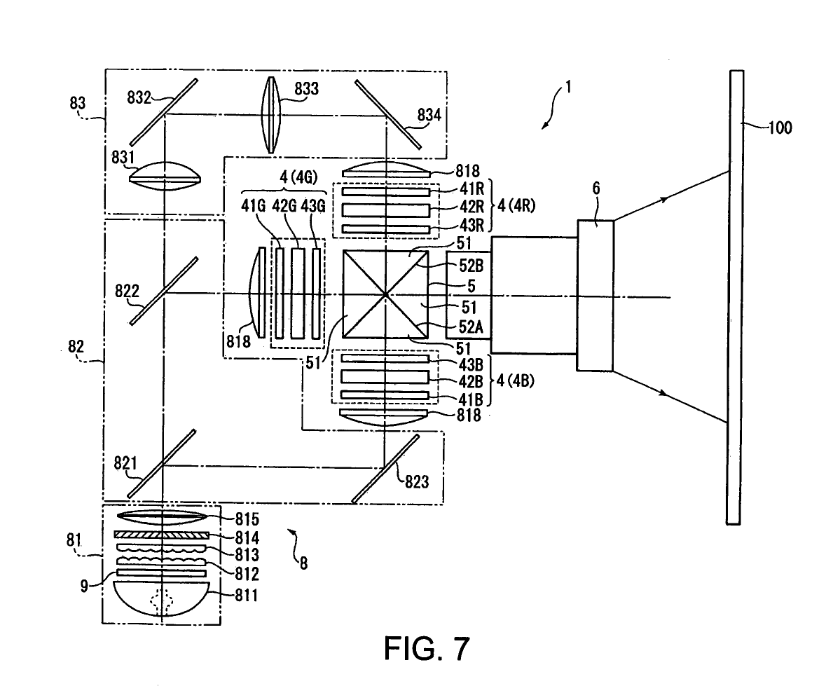

FIG. 6 is a block diagram schematically illustrating a liquid crystal projector 1 which is the image display apparatus in a second embodiment according to the invention. FIG. 7 is a plan view schematically illustrating the main part of the liquid crystal projector 1 shown in FIG. 6.

According to the liquid crystal projector 1 in this embodiment, a metal halide lamp 811 which here is the gaseous light emitting source is employed as the light source, and a light blocking member 9 for periodically blocking light emitted from the metal halide lamp 811 are provided. The structure in the second embodiment drastically differs from the structure in the second embodiment in these points.

The gaseous light emitting source may be a halogen lamp, a high-pressure mercury lamp or the like as well as the metal halide lamp 811.

The light blocking member 9 may be formed by a rotational light blocking plate having a plurality of transparent slits at equal circumferential intervals on the circumference of a disk-shaped rotor, or by a plurality of polarization plates overlapping with their lattice axes either aligned with one another or intersecting one another at predetermined angles.

More specifically, the metal halide lamp 811 and the light blocking member 9 are accommodated within an optical unit 8 shown in FIG. 6. Other components included in the optical unit 8 are described below in detail.

The optical unit 8 includes an integrator illumination optical system 81, a color separation optical system 82, and a relay optical system 83.

The integrator illumination optical system 81 illuminates the image forming regions of the liquid crystal panels 42R, 42G and 42B approximately uniformly. The integrator illumination optical system 81 has the metal halide lamp 811, the light blocking member 9, a first lens array 812, a second lens array 813, a polarization conversion element 814, and a superposing lens 815. The position of the light blocking member 9 may be appropriately determined in accordance with the specific structure thereof, such as at the position behind the superposing lens 815.

The first lens array 812 is constituted by small lenses each of which has a substantially rectangular contour as viewed from the direction of the optical axis and are arranged in matrix. Each of the small lenses divides light emitted from the metal halide lamp 811 into a plurality of divided lights.

The second lens array 813 has approximately the same structure as that of the first lens array 812, and contains small lenses arranged in matrix. The second lens array 813 functions together with the superposing lens 815 to form images coming from the respective small lenses of the first lens array 812 on the liquid crystal panels 42R, 42G and 42B.

The polarization conversion element 814 disposed between the second lens array 813 and the superposing lens 815 converts the lights coming from the second lens array 813 into polarized lights of substantially one-type.

The color separation optical system 82 has two dichroic mirrors 821 and 822 and a reflection mirror 823, and separates the plural partial lights emitted from the integrator illumination optical system 81 into lights in three colors of red, green and blue using the dichroic mirrors 821 and 822.

The relay optical system 83 has an entrance-side lens 831, a relay lens 833, and reflection mirrors 832 and 834, and guides the red light separated by the color separation optical system 82 to the liquid crystal panel 42R.

In the optical unit 8 having the above structure, the blue light of the lights emitted from the integrator illumination optical system 81 is reflected by the dichroic mirror 821 and the red and green lights pass therethrough. The blue light reflected by the dichroic mirror 821 is further reflected by the reflection mirror 823, pass through a field lens 818, and reaches the liquid crystal panel 42B. The field lens 818 converts the partial lights emitted from the second lens array 813 into lights parallel to the center axis (principal ray) of the field lens 818. The field lenses 818 disposed in the vicinity of the light-entrance side of the liquid crystal panels for green and red lights have structures similar to that of the field lens 818 for blue light.

The red and green lights pass through the dichroic mirror 821, but then only the green light is reflected by the dichroic mirror 822, passes through the field lens 818, and reaches the liquid crystal panel 42G. The red light passes through the dichroic mirror 822, the relay optical system 83 and the field lens 818, and reaches the liquid crystal panel 42R.

In this embodiment, a control signal for light transmission for controlling the operation of the light blocking member 9 is outputted from the display controller 72 of the driving device 7. The control signal allows light to be emitted from the light blocking member 9 in accordance with predetermined light transmission timing within the frame cycle, so that the light can illuminate the liquid crystal panels 42R, 42G and 42B intermittently and periodically. Similarly to the first embodiment, the control signal is produced at the control signal producing section 142 of the image signal converting device 10 (FIG. 4) connected to the liquid crystal projector 1, and outputted through the display controller 72.

Other components included in the liquid crystal projector 1 in this embodiment are similar to those of the liquid crystal projector 1 in the first embodiment, and explanation of those components is not repeated herein. When the image signal converting device 10 described in the first embodiment is connected to the liquid crystal projector 1 in the second embodiment, the liquid crystal projector 1 can display an image in accordance with the image signal corrected by the image signal converting device 10, thereby providing advantages similar to those in the first embodiment.

It should be stated that the invention is not limited to the examples described and depicted. In light of the above teachings, it is therefore to be understood that other modifications and improvements may be made within the spirit and scope of the invention.

For example, in the above embodiments, the light passing through the respective pixels of the liquid crystal panels 42R, 42G and 42B is intermittent light which passes only for a predetermined period within the frame cycle. However, the light may pass for the entire period of the frame cycle. In this case, since there is a possibility of light leaks within the frame cycle, it is preferable to prepare additional correction parameters determined considering the light leak characteristics so that the image signal can be more precisely corrected.

In the above embodiments, the control signal for light transmission for controlling the LED driving circuit 21 and the light blocking member 9 are produced by the control signal producing section 142 included in the image signal converting device 10. However, such a control signal producing section may be included in an image display apparatus such as a liquid crystal projector.

In the above embodiments, light emitted from the LEDs 2 or the metal halide lamp 811 illuminates the entire regions of the liquid crystal panels 42R, 42G and 42B. However, light may be made to pass through predetermined regions of the liquid crystal panels 42R, 42G and 42B using a polygon mirror or other means. In this case, the regions through which light passes are shifted by the rotation of the polygon mirror, and the entire regions of the illumination surfaces are scanned so that images of one frame can be displayed.

In the above embodiments, the liquid crystal projector 1 and the image signal converting device 10 are provided as separate units. Obviously, the image signal converting device according to the invention may be included in an image display apparatus such as a liquid crystal projector.

In the above embodiments, the liquid crystal projector 1 projecting an image on the screen 100 has been explained as a projection-type display apparatus. However, the image display apparatus according to the invention may be a so-called liquid crystal rear projector, or may be of direct-viewing type such as a liquid crystal display provided with backlighting other than of projection type.

In the above embodiments, the three-plate-type liquid crystal projector 1 has been explained. However, the invention is applicable to a single-plate-type liquid crystal projector.

While the liquid crystal panels used in the above embodiments are transmissive-type liquid crystal panels, they may be reflection-type liquid crystal panels.

The image display apparatus using a liquid crystal panel and the method for operating the liquid crystal panel according to the invention are applicable to various types of liquid crystal projectors, for instance direct-viewing-type liquid crystal displays equipped with backlighting.

The entire disclosure of Japanese Patent Application No. 2004-350812, filed Dec. 3, 2004 is expressly incorporated by reference herein.

What is claimed is:

1. An image display apparatus for displaying an image using a liquid crystal panel, comprising:
a parameter storing section for storing correction parameters associated with response characteristics for voltage applied to each pixel of the liquid crystal panel; and
a parameter reading section for reading the correction parameters stored in the parameter storing section, wherein:
the liquid crystal panel is operated in accordance with an image signal corrected based on the correction parameters read by the parameter reading section.

2. An image display apparatus according to claim 1, further comprising a device that passes light which allows light emitted from a light source to pass through pixels only for a predetermined period within a frame cycle of an image.

3. An image display apparatus according to claim 2, wherein:
the light source is a solid light source; and
the device that passes light is a driving circuit for allowing the solid light source to be periodically turned on and off.

4. An image display apparatus according to claim 2, wherein:
the light source is a gaseous light emitting source; and
the device that passes light is a blocking member for periodically blocking light emitted from the gaseous light emitting source.

5. An image signal converting device, comprising:
a data converting section for correcting an image signal for each pixel based on the correction parameters obtained from the image display apparatus according to claim 1; and
a data output section for outputting the corrected image signal to the image display apparatus.

6. An image signal converting device according to claim 5, further comprising a control signal producing section which produces a control signal for controlling the device that passes light provided on the image display apparatus.

7. An image signal converting method, wherein the image signal converting device according to claim 5 executes:
correcting an image signal based on correction parameters for each pixel obtained from the image display apparatus according to claim 1; and
outputting the corrected image signal to the image display apparatus.

8. An image signal converting method according to claim 7, wherein:
the correction parameters are divided into a plurality of groups, and a coefficient table in which the groups and the correction parameters are associated and a pixel table in which pixels are associated with their respective groups are prepared; and
the image signal converting device determines the group corresponding to each pixel from the pixel table, selects the correction parameters corresponding to the determined group from the coefficient table, and corrects the image signal based on the selected correction parameters.

9. An image signal converting program, under which the image signal converting device using a computer according to claim 5 executes:
correcting an image signal for each pixel based on correction parameters obtained from the image display apparatus according to claim 1; and
outputting the corrected image signal to the image display apparatus.
